(19) United States
(12) Patent Application Publication
(10) Pub. No.: US 2005/0205748 A1
(43) Pub. Date: Sep. 22, 2005

(54) Holding apparatus for positioning subscriber identification module card

(76) Inventor: Chen Chih Jen, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/918,988

(22) Filed: Aug. 16, 2004

(30) Foreign Application Priority Data
Mar. 16, 2004 (TW) 093107019

(51) Int. Cl. H04Q 7/20

(52) U.S. Cl. 248/463; 248/439

(57) ABSTRACT

A holding apparatus for positioning a subscriber identification module (SIM) card, comprises: a first and a second coupling structures disposed on a fixing surface; a first interference pin, formed at the first coupling structure and protruded toward the second coupling structure; a U-shaped frame having a first, a second and a third arms. When the U-shaped frame is disposed at a first position, the first arm is under the first interference pin, and the SIM card is restricted between the U-shaped frame and the fixing surface. When the U-shaped frame is disposed at the second position, the first arm is above the first interference pin and the SIM card can be removed. When the U-shaped frame is rotated between the first and the second positions, the elastic force generated from the deformed U-shaped frame facilitates the movement of the first arm towards either the first position or the second position.

This application claims the benefit of Taiwan application Serial No. 093107019, filed Mar. 16, 2004, the subject matter of which is incorporated herein by reference.

### BACKGROUND OF THE INVENTION

1. Field of the Invention

The invention relates in general to a holding apparatus for positioning the subscriber identification module (SIM) card, and more particularly to the holding apparatus for easily securing and removing the SIM card.

2. Description of the Related Art

The subscriber identification module (SIM) card is key element GSM (Global System for Mobile) mobile phone. Although the SIM card is as tiny as the size of a first class postage stamp, it is actually a tiny computer in the mobile phone. The SIM card typically have 16 to 64 kb of memory, which provides plenty of room for storing hundreds of personal phone numbers, text messages and value-added services. SIM Application Toolkit is a technology that lets the SIM card issue commands to the telephone. These commands range from displaying menus and getting user input, to sending and receiving SMS messages. SIM Toolkit is essential for implementing security critical applications, since it allows for custom encryption. With the SIM card and SIM Toolkit, the mobile operators (user) have strong authentication, for clearly identifying a user for billing purposes and preventing the fraudulent use of the system; data confidentiality, ensuring that users have a private conversation; and user anonymity, protecting the location and identity of a caller.

In GSM security implementation, authentication, used to identify the user to the network operator, is essential to ensure accurate billing and prevent unwarranted use of the system. One of the most useful services of the GSM network is that of mobility; users can use the same SIM card in any mobile phone and still receive the same services. Subscriber Authentication in a GSM network first relies on a unique secret value (PIN) inserted into each SIM card. Once the mobile equipment has validated the user, the network then uses a “challenge-response” technique to authenticate the subscriber. A 128 bit random number R is issued as a challenge to the mobile station, the MS encrypts the challenge using the authentication algorithm (A3), and a secret key (K1) assigned to the mobile. The keys and algorithms are stored on the SIM card, and in an Authentication Centre. The 32 bit signed response SRES is compared to the results of running the stored key through the same algorithm at the Authentication Centre. If the SRES is equal to the Authentications Centres result then the subscriber is authenticated. A mobile may be “challenged” at any time to ensure authentication.

In the commercial market, there are various ways to mount the SIM card in the housing of the mobile phone. For example, the metallic hooks is formed at either ends of the receiving space for securely holding the SIM card; or the SIM card is placed in the receiving space with particular alignment edges (such as cropped corner) and then covered by the SIM card door and the battery unit. However, the former provides a very difficult way to access the SIM card, and it is possible to damage the SIM card (such as scratching the surface or damaging the inner electrical components) during accessing. The latter may have the concern about careless drop out or missing of SIM card during the replacement of the battery unit. In practice it would be desirable to design a holding apparatus able to well position the SIM card and also allow easy access.

### SUMMARY OF THE INVENTION

It is therefore an object of the invention to provide a holding apparatus for positioning the subscriber identification module (SIM) card. According to the arrangement between a substantially U-shaped frame and the interference pin (and/or the lock pins), the SIM card can be well positioned or easily removed without causing any damage.

The invention achieves the objects by providing a holding apparatus, applied in an electronic device such as a portable phone, for positioning the SIM card in a receiving space. The holding apparatus comprises:
a first coupling structure and a second coupling structure, both of them disposed on a fixing surface and forming a virtual rotating axis;
a first interference pin, protruding from the first coupling structure and extended toward the second coupling structure; and
a substantially U-shaped frame, comprising a first arm, a second arm and a third arm, wherein the first arm has a first coupling portion and a first joint portion, the second arm has a second coupling portion and a second joint portion, the third arm is formed between the first joint portion and the second joint portion, the first coupling portion and the second coupling portion are respectively coupled to the first coupling structure and the second coupling structure, thereby allowing the substantially U-shaped frame pivoting around the virtual rotating axis between a first position and a second position.

When the substantially U-shaped frame is disposed at the first position, the first arm is disposed under the first interference pin, and able to restrict an object between the substantially U-shaped frame and the fixing surface, and the first arm and the second arm are spaced apart for a first distance.

When the substantially U-shaped frame is disposed at the second position, the first arm is disposed above the first interference pin, and the first and the second arms are spaced apart for a second distance.

When the substantially U-shaped frame is disposed between the first position and the second position, the first interference pin presses against the first arm to deform the substantially U-shaped frame thereby making the first arm moving toward the second arm, so the first arm and the second arm are spaced apart for a third distance. The third distance is smaller than one of the first distance and the second distance. The elastic force generated in the deformation of the substantially U-shaped frame facilitates the movement of the first arm towards one of the first position and the second position.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A schematically illustrates a disassembled view of the holding apparatus for positioning the SIM card according to the first embodiment of the invention.

FIG. 1B schematically illustrates a disassembled view of the holding apparatus for positioning the SIM card according to the second embodiment of the invention.

FIG. 1C and FIG. 1D are the perspective views of a rear housing of a portable phone for installing the holding apparatus according to the first embodiment of the invention.

FIG. 2A is a perspective view of the rear housing with the holding apparatus of the first embodiment fully closed for retaining the SIM card.

FIG. 2B is an enlarged view of the holding apparatus of FIG. 2A.

FIG. 3A is a perspective view of the rear housing with the holding apparatus of the first embodiment, wherein the substantially U-shaped frame is at the condition between fully closed and fully opened.

FIG. 3B is an enlarged view of the holding apparatus of FIG. 3A.

FIG. 4 is a perspective view of the rear housing with the holding apparatus of the first embodiment, wherein the substantially U-shaped frame is fully opened.

### DETAILED DESCRIPTION OF THE INVENTION

In the present invention, a holding apparatus for positioning the subscriber identification module (SIM) card is mechanically constructed. The SIM card can be accepted and positioned in a receiving space by rotating a substantially U-shaped frame to a closed position, also, can be removed by rotating the substantially U-shaped frame to an opened position. Therefore, the conventional problems usually occurs during the SIM card replacement, such as carelessly losing the SIM card, scratching the surface or damaging the inner electrical components of the SIM card, are solved according to the invention. In the preferred embodiment of the invention, a portable phone is the applied electronic product for illustrating the holding apparatus for positioning the SIM card in detail.

The embodiment disclosed herein is for illustrating the invention, but not for limiting the scope of the invention. Additionally, the drawings used for illustrating the embodiment of the invention only show the major characteristic parts in order to avoid obscuring the invention. Accordingly, the specification and the drawing are to be regard as an illustrative sense rather than a restrictive sense.

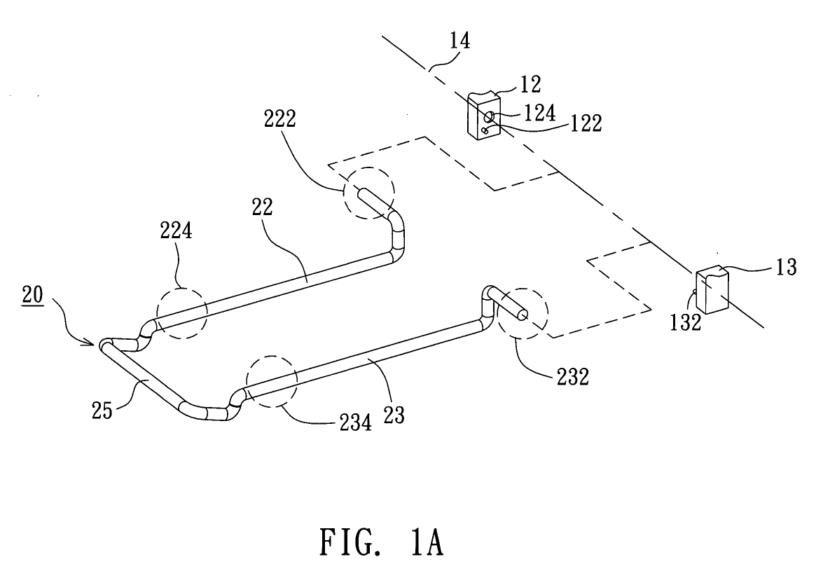

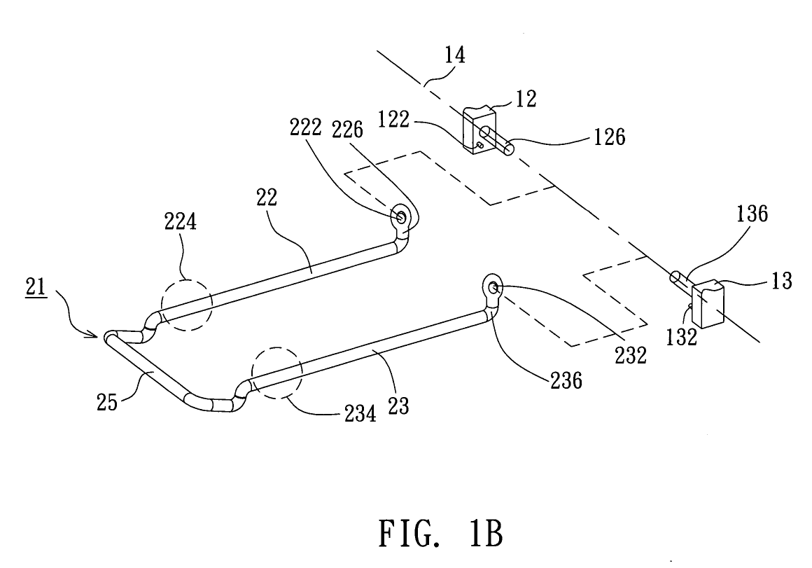

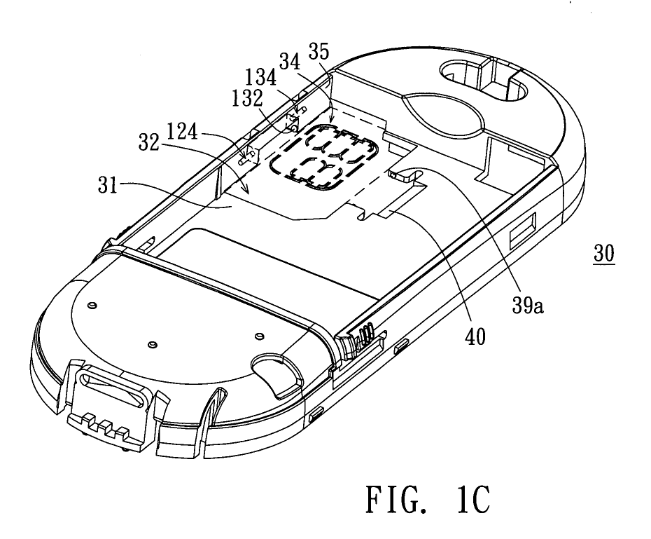

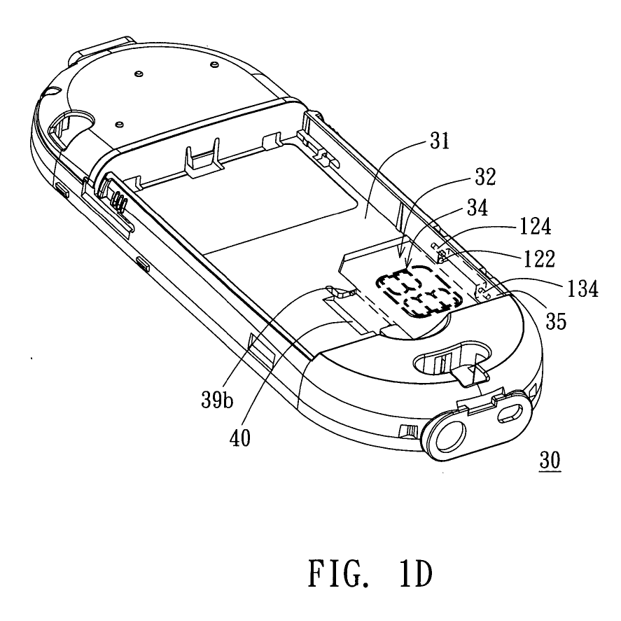

FIG. 1A schematically illustrates a disassembled view of the holding apparatus for positioning the SIM card according to the first embodiment of the invention. The holding apparatus at least comprises a first coupling structure 12, a second coupling structure 13, a first interference pin 122 and a substantially U-shaped frame 20. The first coupling structure 12 and the second coupling structure 13 are disposed on a fixing surface (for example, the bottom surface 31 of the rear housing of the portable phone), and both of them form a virtual rotating axis 14. The first interference pin 122 is formed at the first coupling structure 12 and protruded toward the position of the second coupling structure 13.

The substantially U-shaped frame 20 consists of a first arm 22, a second arm 23 and a third arm 25, wherein the first arm 22 has a first coupling portion 222 and a first joint portion 224, the second arm 23 has a second coupling portion 232 and a second joint portion 234. The third arm 25, placed between a first joint portion 224 and the second joint portion 234, connects the first arm 22 and the second arm 23. Also, the first joint portion of the first arm and the second joint portion of the second arm are connected to the first coupling portion and the second coupling portion, respectively, thereby allowing the substantially U-shaped frame 20 pivoting around the virtual rotating axis 14. The substantially U-shaped frame 20 can be rotated between a first position (i.e. a closed position for retaining the SIM card) and a second position (i.e. a fully opened position for releasing the SIM card).

As shown in FIG. 1A, there is a hole 124 formed in the first coupling structure 12, and the first coupling portion 222 of the first arm 22 functions as an axial rod. During assembly, the first coupling portion 222 is coupled into the hole 124. Also, the axial rod (i.e. first coupling portion 222) is extended along the direction of the virtual rotating axis 14. Therefore, it allows the first coupling portion 222 pivoting around the virtual rotating axis 14 and moving along the direction of the virtual rotating axis 14 after assembly.

It is, of course, understood that another hole could be further formed in the second coupling structure 13 for receiving the second coupling portion 232 (also functioning as an axial rod). The hole of the second coupling structure 13 is formed at a position corresponding to the position of the holes 124.

Also, any suitable coupling structure could be used and the invention is not meant to be limited to the holding apparatus shown in FIG. 1A. Example of other suitable structure, such as the coupling apparatus serving as the axial rod and the first coupling portion configured as a ring with a hole, is described below. FIG.1B schematically illustrates a disassembled view of the holding apparatus for positioning the SIM card according to the second embodiment of the invention. Components common to FIG. 1B retain the same numeric designation. In FIG.1B, the first coupling structure 12 of the substantially U-shaped frame 21 has an axial rod 126, and the first coupling portion 222 of the first arm 22 has a first hole 226. Also, the axial rod 126 is extended along the direction of the virtual rotating axis 14. Therefore, it allows the rotation of the first hole 226 on the virtual rotating axis 14 and the slightly moving along the direction of the virtual rotating axis 14 after assembly. Similarly, the second coupling structure 13 of the substantially U-shaped frame 21 has an axial rod 136, and the second coupling portion 232 of the second arm 23 has a second hole 236. The axial rod 136 is extended along the direction of the virtual rotating axis 14. Therefore, it allows the rotation and slightly movement of the second hole 236 along the direction of the virtual rotating axis 14.

FIG. 1C and FIG. 1D are the perspective views of a rear housing of a portable phone for installing the holding apparatus according to the first embodiment of the invention. The portable phone assembly comprises a front housing, a printed circuit board (PCB), a rear housing and a battery unit. The Figures in the preferred embodiment show the rear housing alone that are necessary for illustrating the invention. The rear housing 30 of a portable phone is provided with a space for placing the battery unit (not shown), also with a receiving space 32 for placing a to-be-positioned object such as a SIM card. Generally, the receiving space 32 is laterally identical to the SIM card. There is a SIM connector 34 in the receiving space 32, and being electrically coupled with the PCB of the portable phone. When the SIM card is placed within the receiving space 32, the SIM card is electrically coupled with the PCB of the portable phone by contacting with the SIM connector 34.

Please also refer to FIG. 1A. The first coupling structure 12 and the second coupling structure 13 are disposed on a fixing surface, such as the bottom surface 31 of the rear housing and being a part of the sidewall thereof. Also, the first interference pin 122 and the hole 124 are formed on the first coupling structure 12. The second interference pin 132 and the hole 134 are formed on the first coupling structure 13.

Moreover, one or couple lock pins could be further formed at the fixing surface for securing the third arm 25. As shown in FIG. 1C and FIG. 1D, the lock pins 39a and 39b are formed at the bottom surface 31 of the rear housing. The projecting directions of the lock pins 39a, 39b, and the first interference pin 122 and the second interference pin 132 are arranged parallel.

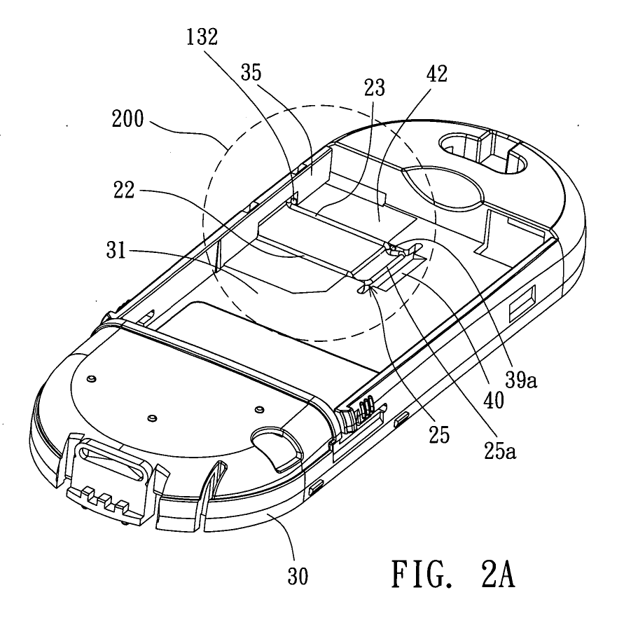

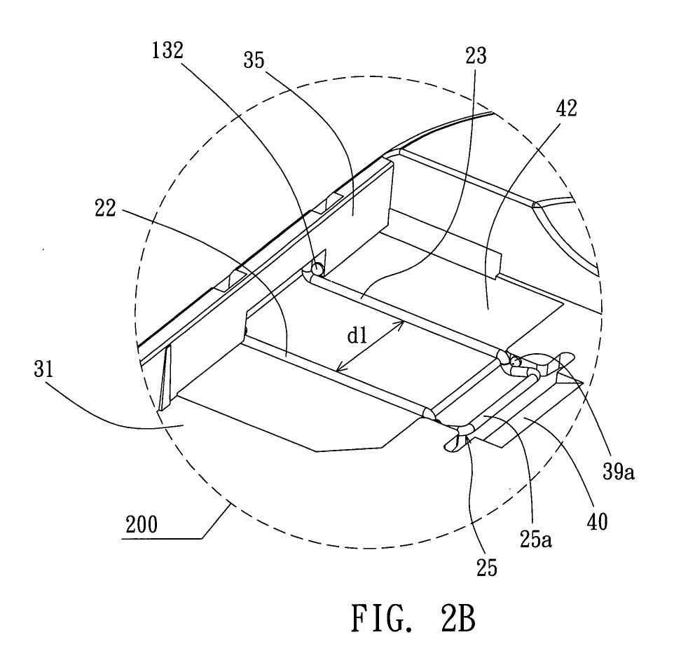

FIG. 2A is a perspective view of the rear housing with the holding apparatus of the first embodiment fully closed for retaining the SIM card. FIG. 2B is an enlarged view of the holding apparatus of FIG. 2A. Please also refer to FIG. 1A, FIG. 1C and FIG. 1D. During assembling, an external force (usually provided by the assembler) could be applied to one of the first arm 22 and the second arm 23 for being able to inserting the first coupling portion 222 and the second coupling portion 232 into the holes 124 and 134, respectively.

After assembling, the substantially U-shaped frame 20 can be disposed at one of a first position and a second position, and rotated there between. When the substantially U-shaped frame 20 is disposed at the first position (i.e. the locking position as shown in FIG. 2A), the first arm 22 is disposed under the first interference pin 122, and capable of restricting the SIM card 42 at the space between the substantially U-shaped frame 20 and the fixing surface such as the bottom surface 31. Meanwhile, the first arm 22 and the second arm 23 are spaced apart for a first distance of d1. Also, the third arm 25 secured by the lock pins 39a and 39b is restricted at the space between the lock pins 39a, 39b and the bottom surface 31.

In this embodiment, the third arm 25 further has a raising end 25a, protruded from the bottom surface 31, and the angle between the raising end 25a and the bottom surface 31 facilitates the user to lift the substantially U-shaped frame 20. Correspondingly, the slant plane 40 on the bottom surface 31 is configured in accordance with the raising end 25a. The slanted angle of the slant plane 40 could be identical to that of the raising end 25a.

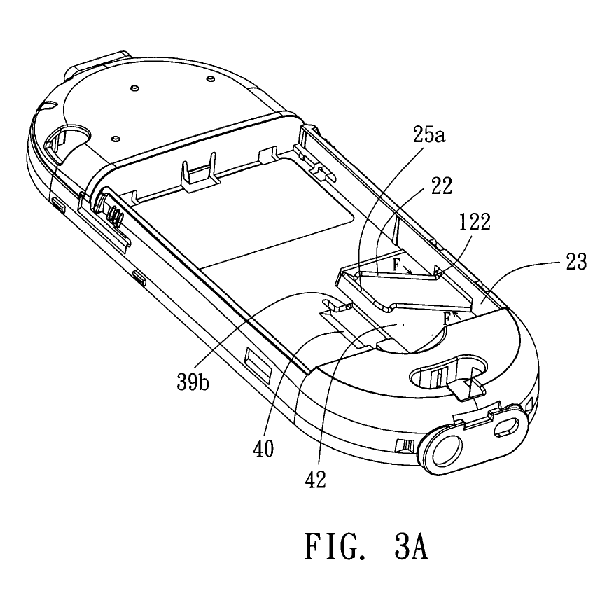

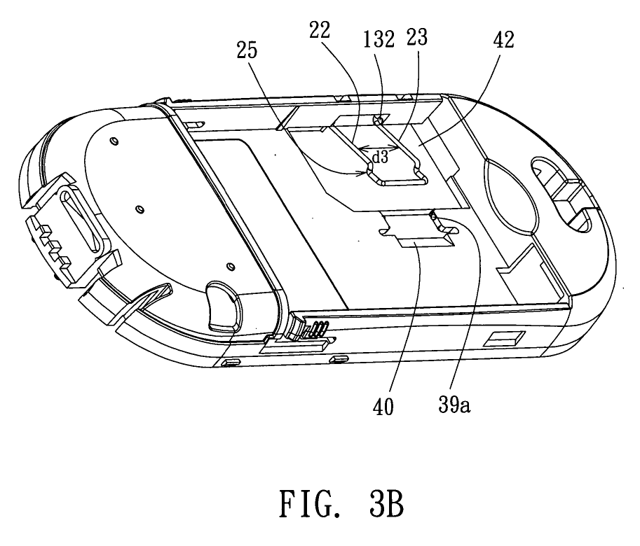

FIG. 3A is a perspective view of the rear housing with the holding apparatus of the first embodiment, wherein the U-shaped frame is at the condition between fully closed and fully opened. FIG. 3B is an enlarged view of the holding apparatus of FIG. 3A.

If the SIM card 42 needs to be removed (for example, change a portable phone in use), it can be easily taken out after opening the substantially U-shaped frame 20. The slant plane 40 helps the user lift the raising end 25a of the third arm 25 so as easily to do the rotation of the substantially U-shaped frame 20.

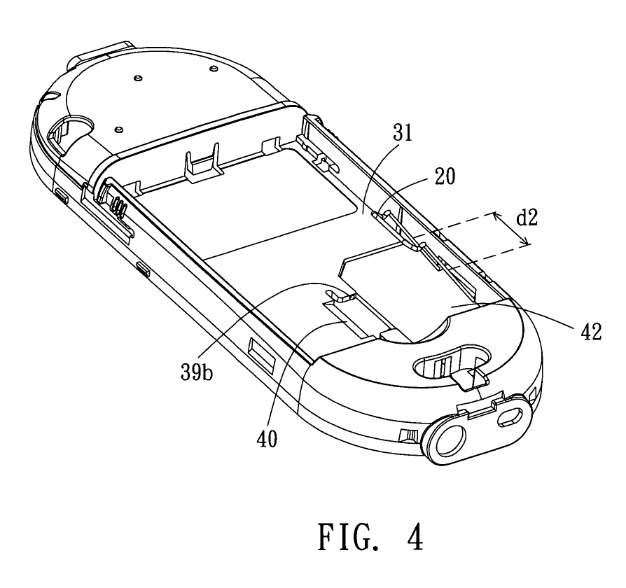

When the substantially U-shaped frame 20 is disposed between the first position (i.e. the locking position as shown in FIG. 2A) and the second position (i.e. the fully-opened position as shown in FIG. 4), the first interference pin 122 and the second interference pin 132 press against the first arm 22 and the second arm 23, respectively. The substantially U-shaped frame 20 is thus deformed; meanwhile, the first arm 22 and the second arm 23 are spaced apart for a third distance of d3 (FIG. 3B), which is shorter than the first distance of d1. The elastic force generated in the deformation of the substantially U-shaped frame 20 facilitates the movement of the first arm 22 towards one of the first position and the second position.

The arrows F in FIG. 3A represent the pressing directions of the first interference pin 122 and the second interference pin 132 acting on the substantially U-shaped frame 20. Also, the arrows F could represent the way that the assembler pushes the first arm 22 and the second arm 23 for assembling the substantially U-shaped frame 20. The substantially U-shaped frame 20 is preferably made of metal and possesses the rebounding property. So, the first arm 22 and the second arm 23 can be forced to approach each other, thereby coupling/removing the first coupling portion 222 and the second coupling portion 232 to/from the holes 124 and 134, respectively. Accordingly, the substantially U-shaped frame 20 can be coupled to or removed from the rear housing of the portable phone in a very simple and convenient way.

FIG. 4 is a perspective view of the rear housing with the holding apparatus of the first embodiment, wherein the U-shaped frame is fully opened. When the substantially U-shaped frame 20 is disposed at the second position (i.e. being fully opened), the first arm 22 is disposed above the first interference pin 122 (which means the substantially U-shaped frame 20 is away from the bottom surface 31) and the SIM card 42 is free to be removed. The first arm 22 and the second arm 23 are spaced apart for a second distance of d2, which is larger than the third distance of d3 (see FIG. 3B, the first arm 22 and the second arm 23 were subjected to the pressure of the first interference pin 122 and the second interference pin 132).

According to this embodiment, the first arm 22 and the second arm 23 have overcome the obstructions (i.e. the first interference pin 122 and the second interference pin 132) while the substantially U-shaped frame 20 is fully opened (FIG. 4). Therefore, the first arm 22 and the second arm 23 can lean against the first interference pin 122 and the second interference pin 132. It is more convenient to remove the SIM card 42 without holding the substantially U-shaped frame 20 by hand. Similarly, the substantially U-shaped frame 20 can be rotated back to the lock position when the first arm 22 and the second arm 23 overcome the first interference pin 122 and the second interference pin 132 in the opposite direction. It is, of course, known by the art that the positions of the first interference pin 122 and the second interference pin 132 have the effect on the opening angle between the substantially U-shaped frame 20 and the bottom surface 31. The invention is not meant to be limited to the relative positions of the substantially U-shaped frame 20 and interference pins shown in all figures of the embodiment.

It is noted that the rotation of the substantially U-shaped frame 20 handles well or not depends on the rubbing of the first arm 22 and the second arm 23 against the first interference pin 122 and the second interference pin 132. Therefore, the first interference pin 122 and the second interference pin 132 are preferably configured to have the smooth tops over which the first arm 22 and the second arm 23 glide.

Although the first interference pin 122, the second interference pin 132, the lock pins 39a and 39b are formed in the receiving space 32, it is, of course, understood that the substantially U-shaped frame 20 could be well positioned by only one set of pins. Formation of the first interference pin 122 and the second interference pin 132 would be the better choice, considering the positioning effect of the substantially U-shaped frame 20 (for example, able to stand at the fully-opened position without supporting by hand).

According to the aforementioned description, the SIM card can be well positioned by the holding apparatus of the invention, using the components of substantially U-shaped frame, the coupling structures, and the interference pins and/or the lock pins. Also, the SIM card can be easily removed by rotating the substantially U-shaped frame to the fully opened position. Thus, the conventional problems, such as carelessly losing the SIM card and scratching the surface or damaging the inner electrical components of the SIM card, can be prevented according to the invention. Moreover, the simple structure according to the embodiments of the invention not only saves the assembling time but also decrease the manufacturing cost.

While the invention has been described by way of examples and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A holding apparatus, comprising:
a first coupling structure and a second coupling structure disposed on a fixing surface, the first coupling structure and the second coupling structure forming a virtual rotating axis;
a first interference pin protruded from the first coupling structure and extended toward the second coupling structure; and
a substantially U-shaped frame, comprising a first arm, a second arm and a third arm, the first arm having a first coupling portion and a first joint portion, the second arm having a second coupling portion and a second joint portion, the third arm formed between the first joint portion and the second joint portion, the first coupling portion and the second coupling portion respectively coupled to the first coupling structure and the second coupling structure, thereby allowing the substantially U-shaped frame pivoting around the virtual rotating axis between a first position and a second position;
when the substantially U-shaped frame being disposed at the first position, the first arm being disposed under the first interference pin, and capable to restrict an object between the substantially U-shaped frame and the fixing surface, and the first arm and the second arm being spaced apart for a first distance;
when the substantially U-shaped frame being disposed at the second position, the-first arm being disposed above the first interference pin, and the first arm and the second arm being spaced apart for a second distance;
when the substantially U-shaped frame being disposed between the first position and the second position, the first interference pin pressing against the first arm to deform the substantially U-shaped frame thereby making the first arm moving toward the second arm, so the first arm and the second arm being spaced apart for a third distance, the third distance being smaller than one of the first distance and the- second distance, and the elastic force generated in the deformation of the U-shaped frame facilitating the movement of the first arm towards either one of the first position and the second position.

2. The holding apparatus according to claim 1, wherein a second interference pin is further formed at the second coupling structure and protruded toward the first coupling structure, when the substantially U-shaped frame is at between the first position and the second position, the second interference pin against the second arm deforms the substantially U-shaped frame, thereby making the second arm approach the first arm.

3. The holding apparatus according to claim 1, wherein the first coupling structure has a hole, and the first coupling portion functions as an axial rod extending along the virtual rotating axis, so as to allow the axial rod pivoting around the virtual rotating axis and movable along the direction of the virtual rotating axis.

4. The holding apparatus according to claim 1, wherein the first coupling structure functions as an axial rod extending along the virtual rotating axis, and the first coupling portion has a hole, so as to allow the hole pivoting around the virtual rotating axis and movable along the direction of the virtual rotating axis.

5. The holding apparatus according to claim 1, wherein the first interference pin has a smooth surface, thereby making the first arm easily move toward either the first position or the second position.

6. The holding apparatus according to claim 1, wherein a lock pin is further formed at the fixing surface, and the third arm is restricted at a space between the lock pin and the fixing surface when the substantially U-shaped frame is at the first position.

7. The holding apparatus according to claim 1, wherein a plurality of the lock pins are further formed at the fixing surface, and two ends of the third arm are restricted at a space between the lock pins and the fixing surface when the substantially U-shaped frame is at the first position.

8. The holding apparatus according to claim 1, wherein the third arm further has a raising end protruded from the fixing surface, so as to facilitate the user to lift the substantially U-shaped frame.

9. The holding apparatus according to claim 1, wherein the fixing surface further comprises a receiving space for placing the object, and a portion of the first arm extends to the receiving space when the substantially U-shaped frame is at the first position.

10. An electronic device, having a receiving space of a housing for placing a to-be-positioned detachable object, the electronic device comprising:
a holding apparatus, for positioning the to-be-positioned detachable object, comprising:
a first coupling structure and a second coupling structure, both of them disposed on a fixing surface and forming a virtual rotating axis;
a first interference pin, formed at the first coupling structure and protruded toward the second coupling structure; and
a substantially U-shaped frame, comprising a first arm, a second arm and a third arm, wherein the first arm has a first coupling portion and a first joint portion, the second arm has a second coupling portion and a second joint portion, the third arm is placed between the first joint portion and the second joint portion, the first coupling portion and the second coupling portion are respectively coupled to the first coupling structure and the second coupling structure, thereby allowing the pivoting of the substantially U-shaped frame on the
virtual rotating axis between a first position and a second position;
when the substantially U-shaped frame being disposed at the first position, the first arm being disposed under the first interference pin, and capable to restrict the to-be positioned detachable object between the substantially U-shaped frame and the fixing surface, and the first arm and the second arm being spaced apart for a first distance;
when the substantially U-shaped frame being disposed at the second position, the first arm being disposed above the first interference pin, and the first arm and the second arm being spaced apart for a second distance;
when the substantially U-shaped frame being disposed between the first position and the second position, the first interference pin pressing against the first arm to deform the substantially U-shaped frame, so the first arm and the second arm being spaced apart for a third distance, the third distance being smaller than one of the first distance and the second distance, and the elastic force generated in the deformation of the substantially U-shaped frame facilitating the movement of the first arm towards either one of the first position and the second position.

11. The electronic device according to claim 10, wherein a second interference pin is further formed at the second coupling structure and protruded toward the first coupling structure, when the substantially U-shaped frame is disposed between the first position and the second position, the second interference pin against the second arm deforms the substantially U-shaped frame, thereby making the second arm approach the first arm.

12. The electronic device according to claim 10, wherein the first coupling structure has a hole and the first coupling portion functions as an axial rod extending along the virtual rotating axis, so as to allow the axial rod pivoting around the virtual rotating axis and movable along the direction of the virtual rotating axis.

13. The electronic device according to claim 10, wherein the first coupling structure functions as an axial rod extending along the virtual rotating axis, and the first coupling portion has a hole so as to allow the hole pivoting around the virtual rotating axis and movable along the direction of the virtual rotating axis.

14. The electronic device according to claim 10, wherein the first interference pin has a smooth surface, thereby making the first arm move easily toward one of the first position and the second position.

15. The electronic device according to claim 10, wherein a lock pin is further formed at the fixing surface, and the third arm is restricted at a space between the lock pin and the fixing surface when the substantially U-shaped frame is at the first position.

16. The electronic device according to claim 10, wherein a plurality of the lock pins are further formed at the fixing surface, and two ends of the third arm are restricted at a space between the lock pins and the fixing surface when the substantially U-shaped frame is at the first position.

17. The electronic device according to claim 10, wherein the third arm further has a raising end protruded from the fixing surface, so as to facilitate the user to lift the substantially U-shaped frame.

18. The electronic device according to claim 10, wherein the receiving space is laterally identical to the to-be-positioned detachable object, and a portion of the first arm extends to the receiving space when the substantially U-shaped frame is at the first position.
